(19) United States
(12) Patent Application Publication
(10) Pub. No.: US 2016/0129654 A1
(43) Pub. Date: May 12, 2016

(54) METHOD OF MANUFACTURING SHOE SOLES AND MOLDS FOR MANUFACTURING SHOE SOLES

(71) Applicant: Shinhwah Co., Ltd, Gyeongsangnam-do (KR)

(72) Inventor: Myeonghee LEE, Gyeongsangnam-do (KR)

(21) Appl. No.: 14/537,467

(22) Filed: Nov. 10, 2014

(51) Int. Cl. B29D 35/14

(52) U.S. Cl. CPC B29D 35/142; B29D 35/148; B29K 2023/083

(57) ABSTRACT

The method of manufacturing shoe soles and molds for manufacturing shoe soles include an injection molding process (S100) by which two-color EVA pellet material (P) is fed into a midsole injection mold (100) and an outsole injection mold (200), which allow the formation of flash (F) protruding from the edges of the midsole and the outsole, so that a midsole (10) and an outsole (20) with different colors are formed; a fitting process (S200) by which the aforementioned injection-molded midsole (10) is coupled with the aforementioned outsole (20); a foam-forming process (S300) by which the aforementioned coupling of the midsole (10) and the outsole (20) and their respective flash (F) are placed in the press mold (300), producing a shoe sole (30); and a trimming process (S400) by which flash (F) on the foam-formed shoe sole (30) is removed.

### BACKGROUND OF THE INVENTION

1. Field of the Invention

The present invention relates to a method of manufacturing shoe soles and molds for manufacturing shoe soles. More specifically, the invention relates to a method of manufacturing shoe soles and molds for manufacturing shoe soles, wherein a two-color shoe sole is produced by injection-molding materials of different colors to clearly define a boundary between the two colors of the sole and then by foam-forming the same.

2. Description of the Related Art

Generally, shoe soles are designed to improve shoe comfort and reduce foot fatigue, and shoe soles that have recently come out are made in various designs to align with varied customer preferences.

Among the various designs of shoe soles, the most popular type is the shoe sole with two colors. Research has been actively conducted on methods and molds for manufacturing two-color shoe soles. The most commonly used technology is the technology of producing high-quality foam among thermoplastic resins, through which EVA (ethylene vinyl acetate) with high elasticity and restoring force even at low specific gravity is used to pour and then pressure the resin into upper and lower molds while a middle mold is coupled, then a midsole and an outsole that constitute a shoe sole are injection-molded, the middle mold is removed, the upper and lower molds are pressured to produce the midsole and the outsole.

However, the conventional technology described above requires a separate middle mold aside from upper and lower molds that constitute a shoe sole, leading to an increase in the cost of manufacturing molds. Furthermore, the technology allows the colors of a midsole and of an outsole to get mixed up, blurring the color boundary around the edges of the sole, when the midsole and the outsole are foam-formed into a shoe sole by injection-molding the midsole and the outsole and pressuring the upper and the lower molds.

To prevent the color-mixing on the boundary, Republic of Korea patent registration No. 10-0367847 “A Method of Manufacturing Shoe Soles and Molds for Manufacturing Shoe Soles” has been published. Through the invention, grooves are formed on the edges of an outsole in a lower mold so that a material for the outsole is pushed out to the grooves during foam-forming, preventing the outsole color from penetrating into the midsole. However, the method of manufacturing that creates flash when using grooves during the foam-forming process has limitations in that the color boundary of a shoe sole is not clearly defined.

### SUMMARY OF THE INVENTION

### Technical Problem

It is therefore an object of the present invention to solve the aforementioned problem by providing a method of manufacturing shoe soles, wherein a midsole and an outsole are injection-molded to create flash around the edges of the midsole and the outsole and then the shoe sole is foam-formed, so that a boundary can be clearly defined for the two-color sole to prevent the penetration of the colors of the midsole and the outsole during production of a two-color shoe sole.

It is another object of the invention to provide a midsole injection mold and an outsole injection mold that allow the formation of flash around the edges of the midsole and the outsole as well as a press mold that can accommodate flash from the midsole and the outsole, respectively, during foam formation.

### Solution to Problem

To achieve the aforementioned objects, the present invention provides a method of manufacturing shoe soles and molds for manufacturing shoe soles comprising an injection molding process (S100) by which two-color EVA pellet material (P) is fed into a midsole injection mold (100) and an outsole injection mold (200), which allow the formation of flash (F) protruding from the edges of the midsole and the outsole, so that a midsole (10) and an outsole (20) with different colors are formed; a fitting process (S200) by which the aforementioned injection-molded midsole (10) is coupled with the aforementioned outsole (20); a foam-forming process (S300) by which the aforementioned coupling of the midsole (10) and the outsole (20) and their respective flash (F) are placed in the press mold (300), producing a shoe sole (30); and a trimming process (S400) by which flash (F) on the foam-formed shoe sole (30) is removed.

The aforementioned fitting process includes checking the volume and weight of the aforementioned injection-molded midsole and outsole.

After the aforementioned foam-forming produces, an additional process of expanding and curing the foam-formed shoe sole is added.

Furthermore, after the aforementioned trimming process, an inspection process is added during which the appearance and dimensions of the trimmed shoe sole are checked.

Lastly, molds for manufacturing shoe soles comprise a midsole injection mold (100) and an outsole injection mold (200), which create shapes for the midsole (10) and the outsole (20), provide a midsole portion (150) and an outsole portion (250) created by coupling a primary upper portion (110) where an upper midsole portion (150a) is formed and a primary lower portion (130) where a lower midsole portion (150b) is formed, and allow the creation of space (S) for flash (F) around the edges of the aforementioned midsole portion (150) and the outsole portion (250); and a press mold (300) including a sole portion (350) where the coupling of the midsole (10) and the outsole (20) is placed and additional space (S) is created around the edges of the aforementioned sole portion (350) to accommodate flash (F) from the midsole (10) and the outsole (20).

### Beneficial Effects

According to the invention described above, the following benefits can be expected:

Foam-forming a shoe sole by creating flash helps to clearly define a color boundary on the shoe sole. Consequently, the process prevents waste from being generated due to color defects and improves the quality of two-color shoe soles.

Furthermore, the method eliminates the need for intermediate plates or intermediate molds, preventing materials from being wasted during injection molding. It also makes it easy to change colors for midsoles and outsoles, since injection molds are separated from press molds.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a process flowchart of the present invention.

FIG. 2 is a perspective view of the process by which a shoe sole is produced according to the manufacturing method of the present invention.

FIG. 3 is a section view of a midsole injection mold according to the present invention.

FIG. 4 is a section view of an outsole injection mold according to the present invention.

FIG. 5 is a section view of a press mold according to the present invention.

### DETAILED DESCRIPTION OF THE PREFERRED EMBODIMENTS

The following is a detailed description of preferred embodiments of the present invention by referring to the attached drawings.

To begin with, the present invention is also called “Ibari,” wherein flash, which refers to burr occurring on the edges of a product of injection or press molding, is intentionally created to clearly define a boundary on a two-color shoe sole. More specifically, flash is intentionally created on the edges of a midsole and an outsole constituting a two-color shoe sole, so that the present invention causes the colors of the midsole and the outsole to penetrate into their respective flash areas and the color boundary to be clearly defined between the edges of the midsole and the outsole by cutting off the flash, thereby solving the problem with the conventional technology where colors are mixed up on the contact area between the midsole and the outsole (boundary).

First of all, the method of manufacturing shoe soles in the present invention can be executed using a variety of thermoplastic resins, but EVA pellets are used to describe preferred embodiments of the present invention.

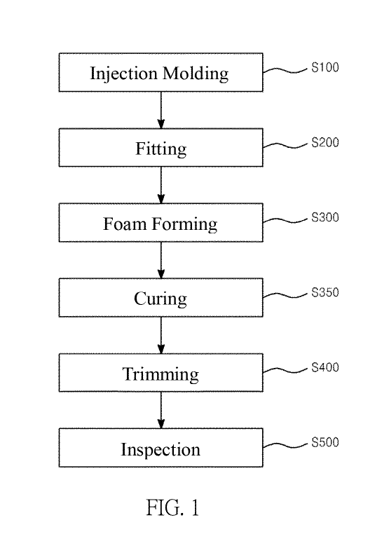

As illustrated in FIG. 1, the method of manufacturing shoe soles of the present invention comprises an injection molding process (S100), fitting process (S200), foam-forming process (S300), and trimming process (S400).

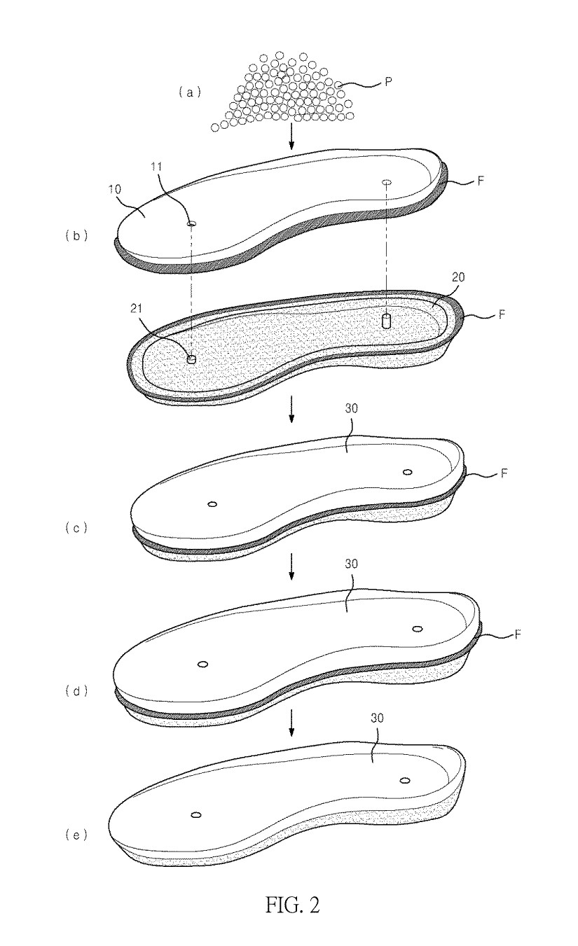

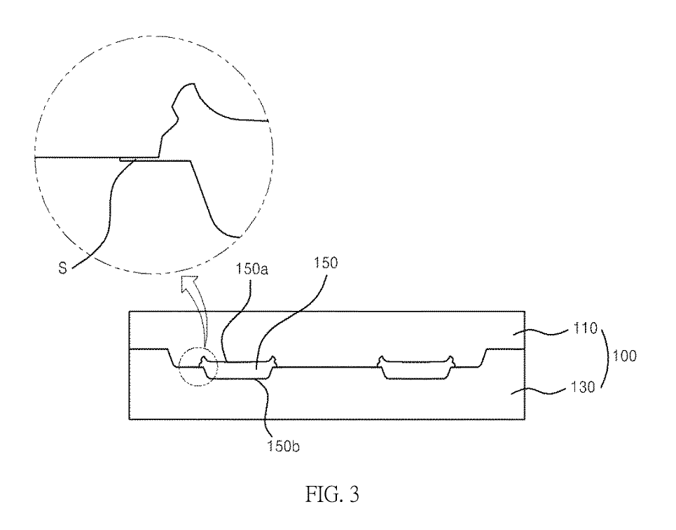

FIGS. 2 to 5 are used to describe the aforementioned processes respectively. FIG. 2 represents a process chart for producing two-color shoe soles according to the present invention. FIG. 2-(a) is a drawing of EVA pellets used in the present invention, FIG. 2-(b) is a drawing of injection-molded midsole and outsole, FIG. 2-(c) is a drawing of an integrated sole made through the foam-forming process where a midsole and an outsole are fitted together, FIG. 2-(d) is a drawing of an expanded and cured two-color shoe sole after being foam-formed, and FIG. 2-(e) is a drawing of a two-color shoe whose flash is removed through the trimming process. FIGS. 3, 4, and 5 represent a midsole injection mold, an outsole injection mold, and a press mold, respectively, for manufacturing shoe soles according to the present invention.

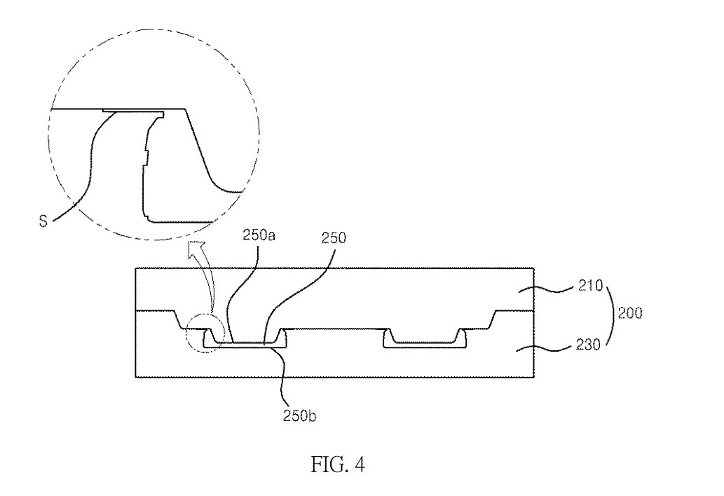

As illustrated in FIG. 2-(b), FIG. 3 or FIG. 4, the aforementioned injection molding process (S100) is a process by which a midsole (10) and an outsole (20) with different colors are created to constitute a two-color shoe sole by pouring EVA pellets (P) with different colors into a midsole injection mold (100) and an outsole injection mold (200) where flash (F) protruding from the edges of the midsole (10) and the outsole (20) can be created.

The aforementioned flash (F) is created in a space as illustrated in FIG. 3 or FIG. 4. The flash (F) created in the aforementioned space (S) is formed on the lower surface of the midsole (10) and the top surface of the outsole (20), namely, an interface where the midsole (10) and the outsole (2) are to be bonded together, and the midsole (10) and the outsole (20) are injection-molded to meet the dimensional, weight and volume requirements before the foam-forming process, since the injection-molded parts shrink at normal temperatures once removed from the molds.

In addition, the temperature applied to the midsole injection mold (100) and the outsole injection mold (200) varies depending on the thermoplastic resin, but in the present invention, the midsole (10) and the outsole (20) are injection-molded by heating EVA pellets (P) for 50 to 70 seconds at 60 to 80° C. to prevent the EVA material from expanding due to the heat. Moreover, in a preferred embodiment, multiple protrusions (21) are created on top of the outsole (20) and perforations (11) are formed on the midsole (10) to fit the protrusions (21) to make it easier to couple the midsole (10) and the outsole (20) during the fitting process (S200) following the injection molding process (S100).

Then the fitting process (S200), the injection-molded midsole (10) and outsole (20) containing flash (F) are fitted together. The fitting process (S200) comes before the foam-forming process (S300) and includes checking accurate dimensions, weights, and volumes by taking account of the shrinking of the injection-molded midsole (10) and outsole (20). As described above, the protrusions (21) of the outsole (20) and the perforations (11) of the midsole are fitted together to implement the fitting process (S300) more precisely.

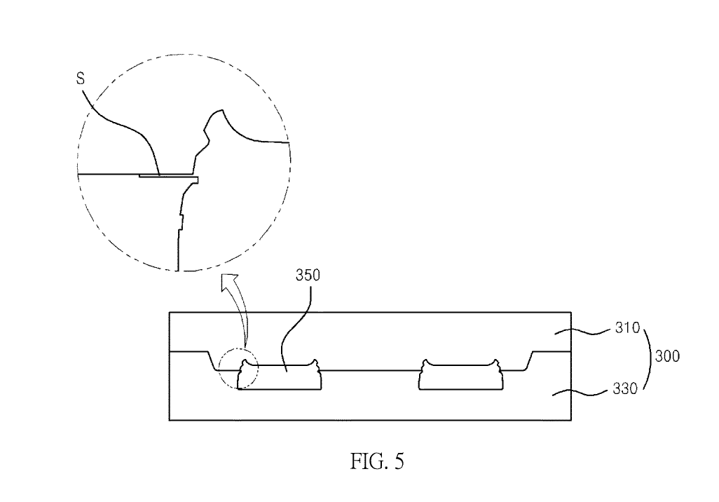

As illustrated in FIGS. 2-(c) and 5, the foam-forming process (S300) is a process by which the coupled midsole (10) and outsole (20) are placed in the press mold (300) which can accommodate the flash (F) of the sole portions, producing a shoe sole (30). The midsole (10) and the outsole (20) as well as their respective flash (F) are accommodated in the space (S) as illustrated in FIG. 5. According to the method of manufacturing shoe soles in the present invention, the foam-forming process (S300) is characterized as follows, relative to the conventional technology:

The biggest problem with the conventional foam formation through which a midsole (10) and an outsole (20) are formed into a shoe sole is that a boundary is not clearly defined between the edges of the midsole (10) and the outsole (20) when they are coupled by temperature and pressure. In other words, the injection molding process (S100) of the present invention allows the formation of flash (F) on the edges of the midsole (10) and the outsole (20), preventing the colors from getting mixed up on the contact area between the midsole (10) and the outsole (20). However, according to the conventional technology, colors are mixed up on the contact area between the midsole (10) and the outsole (20) due to the crosslinking reaction caused by the temperature and pressure applied to foam-formation. It only creates flash (F) while the colors have already started getting mixed up. Therefore, even if the flash (F) is cut off after foam-formation, the contact area between the midsole (10) and the outsole (20), or the color boundary, causes color defects.

On the other hand, the present invention allows flash (F) to be formed on the edges of the midsole (10) and the outsole (20) during the injection molding process (S100), so that the respective flash (F) parts of the midsole (10) and the outsole (20) come into contact during the foam-forming process (S300) of the invention, unlike the conventional technology. In other words, the present invention encourages color penetration on the contact area between the flash (F) parts of the midsole (10) and the outsole (20) so that the color boundary of the shoe sole (30) can be clearly defined when the flash (F) is cut off during the trimming process (S400). In sum, unlike the conventional technology which creates flash (F) during foam-formation, the present invention is an advanced process that can fundamentally prevent color penetration on a color boundary by allowing flash (F) to be formed during the injection molding process (S100).

The pressure and temperature applied during the foam-forming process (S300) may vary depending on the thermoplastic resin, but in the preferred mode of the present invention, the coupling of the injection-molded midsole (10) and outsole (20) is heated at 167° C.-187° C. for 470 to 490 seconds under 130 kg/cm² to 150 kg/cm², so that the color boundary of the shoe sole (30) can be clearly defined by cutting off flash (F) during the trimming process (S400). As illustrated in FIG. 2-(c), appropriate types of crosslinking and foaming agents and their appropriate mixture ratio should be determined to couple the midsole (10) and the outsole (20) and integrate them into the shoe sole (30) by applying the foam-forming temperature and pressure.

As illustrated in FIG. 2-(d), the method of manufacturing shoe soles in the present invention includes a curing process (S350) by which the foam-formed shoe sole (30) after the foam-forming process (S300) is removed from the press mold (300) and expanded and cured at room temperature. The shoe sole (30) foam-formed and removed from the mold is expanded and cured at a pre-set ratio to achieve the desired shape of the sole (30).

As illustrated in FIG. 2-(e), the aforementioned trimming process (S400) is a process by which flash (F) is removed from the foam-formed shoe sole (30) to polish the appearance of the sole (30). In other words, the color boundary of the foam-formed shoe (30) can be clearly defined by removing flash (F) from the sole (30) during the trimming process (S400).

In addition, an inspection process (S500) where the appearance and dimensions of the trimmed shoe sole (30) are checked is performed to check for defects in appearance and achieve the desired dimensions and weight of the shoe (30).

The method of manufacturing shoe soles according to the present invention has been described. The following is a detailed description of molds for manufacturing shoe soles.

As illustrated in FIGS. 2, 3, and 5, molds for manufacturing shoe soles in the present invention comprise a midsole injection mold (100), an outsole injection mold (200), and a press mold (300).

First, the midsole injection mold (100) includes a midsole portion (150) where the shape of the midsole (10) is determined and a space (S) for flash (F) of the midsole (10) is created on the edge of the midsole portion (150). More specifically, the midsole injection mold (100) is created by coupling a primary upper portion (110) where an upper midsole portion (150a) is formed and a primary lower portion (130) where a lower midsole portion (150b) is formed, and a space (S) for flash (F) of the midsole (10) is created on the edge of the lower midsole portion (150b) before injection molding is performed.

The outsole injection mold (200) includes an outsole portion (250) where the shape of the outsole (20) is determined and a space (S) for flash (F) of the outsole (20) is created on the edge of the outsole portion (250). More specifically, the outsole injection mold (200) is created by coupling a secondary upper portion (210) where an upper outsole portion (250a) is formed and a secondary lower portion (230) where a lower outsole portion (250b) is formed, and a space (S) for flash (F) of the outsole (20) is created on the edge of the lower outsole portion (250b) before injection molding is performed.

Then, the aforementioned press mold (300) includes a sole portion (350) where the midsole (10) and the outsole (20) are fitted together and placed, and a space (S) is created to accommodate flash (F) from the midsole (10) and the outsole (20). More specifically, the press mold (300) is created by coupling an upper press mold part (310) in the same shape as the primary upper portion (110) of the midsole injection mold (100) to a lower press mold part (330) in the same shape as the secondary lower portion (230) of the outsole injection mold (200), and accommodates flash (F) from the midsole (10) and the outsole (20). Then, by pressuring the upper press mold part (310) and the lower press mold part (330), foam-formation can be performed.

The basic idea of the present invention is that, in order to prevent the penetration of the colors of a midsole and an outsole during form formation while manufacturing a two-color shoe sole, the invention provides a method of manufacturing shoe soles that can clearly define a color boundary on a shoe sole by injection-molding a midsole and an outsole so that flash can be created on their edges and then foam-forming the same.

Furthermore, the basic idea of the invention is also to provide molds for manufacturing shoe soles comprising a midsole injection mold and an outsole injection mold through which flash can be formed on the edges of midsole and outsole, as well as a press mold including a midsole and an outsole during foam formation to accommodate their respective flash. Different embodiments of the invention can be implemented by a person having ordinary skill in the art.

What is claimed is:

1. A method of manufacturing shoe soles comprising:
performing an injection molding process (S100) by which two-color EVA pellet material (P) is fed into a midsole injection mold (100) and an outsole injection mold (200), which allow the formation of flash (F) protruding from the edges of the midsole and the outsole, so that a midsole (10) and an outsole (20) with different colors are formed;
performing a fitting process (S200) by which the aforementioned injection-molded midsole (10) is coupled with the aforementioned outsole (20);
performing a foam-forming process (S300) by which the aforementioned coupling of the midsole (10) and the outsole (20) and their respective flash (F) are placed in the press mold (300), producing a shoe sole (30); and
performing a trimming process (S400) by which flash (F) on the foam-formed shoe sole (30) is removed.

2. The method of manufacturing shoe soles of claim 1,
wherein the aforementioned fitting process (S200) includes checking the volume and weight of the injection-molded midsole (10) and outsole (20).

3. The method of manufacturing shoe soles of claim 1,
wherein, following the aforementioned foam-forming process (S300), performing a curing process (S350) for expanding and curing the foam-formed shoe sole (30) is added.

4. The method of manufacturing shoe soles of claim 1,
wherein, following the aforementioned trimming process (S400), performing an inspection process (S500) for checking the appearance and dimensions of the trimmed shoe sole (30) is implemented.

5. Molds for manufacturing shoe soles comprising:
a midsole injection mold (100) and an outsole injection mold (200), which create shapes for the midsole (10) and the outsole (20), provide a midsole portion (150) and an outsole portion (250) created by coupling a primary upper portion (110) where an upper midsole portion (150a) is formed and a primary lower portion (130) where a lower midsole portion (150b) is formed, and allow the creation of space (S) for flash (F) around the edges of the aforementioned midsole portion (150) and the outsole portion (250); and
a press mold (300) including a sole portion (350) where the coupling of the midsole (10) and the outsole (20) is placed and additional space (S) is created around the edges of the aforementioned sole portion (350) to accommodate flash (F) from the midsole (10) and the outsole (20).
